(19) United States
(12) Patent Application Publication
(10) Pub. No.: US 2026/0105370 A1
(43) Pub. Date: Apr. 16, 2026

(54) BLIND CORESET SELECTION

(71) Applicant: Voxel51, Inc., Ann Arbor, MI (US)

(72) Inventors: Brent Austin Griffin, Dexter, MI (US); Jacob Austin Marks, Weston, CT (US); Jason Joseph Corso, Buffalo, NY (US)

(21) Appl. No.: 19/340,049

(22) Filed: Sep. 25, 2025

Related U.S. Application Data
(60) Provisional application No. 63/701,919, filed on Oct. 1, 2024.

(51) Int. Cl. G06N 20/00

(52) U.S. Cl. CPC G06N 20/00

(57) ABSTRACT

An unlabeled dataset comprising a plurality of data items is received. An embedding for each data item in the plurality of data items is generated using an embedding model. A score for each data item in the plurality of data items is computed using the corresponding embedding by jointly assessing coverage of an embedding space and redundancy. A subset of the plurality of data items is selected based on the computed scores to form a coreset for reduced data processing.

### CROSS REFERENCE TO OTHER APPLICATIONS

This application claims priority to U.S. Provisional Patent Application No. 63/701,919 entitled BLIND CORESET SELECTION: EFFICIENT PRUNING FOR UNLABELED DATA filed Oct. 1, 2024 which is incorporated herein by reference for all purposes.

### BACKGROUND OF THE INVENTION

As machine learning systems scale to accommodate increasingly large and diverse datasets, the need to efficiently select representative subsets, known as coresets, has become more critical. A coreset is a compact subset of data that approximates the full dataset in terms of its utility for training or analysis. Constructing such subsets is essential for reducing computational overhead, accelerating experimentation, and minimizing annotation costs.

However, most real-world datasets are unlabeled, making it difficult to assess which examples are most informative. Without labels, traditional selection strategies such as uncertainty sampling or supervised clustering are not applicable. At the same time, training models on the full dataset is often prohibitively expensive, both in terms of computation costs and time. This creates a bottleneck in the development cycle, where practitioners must either invest heavily in labeling or risk training on suboptimal data. The challenge is further compounded by the need for scalable, domain-agnostic methods that can operate across modalities and data types without extensive tuning or supervision.

### BRIEF DESCRIPTION OF THE DRAWINGS

Various embodiments of the invention are disclosed in the following detailed description and the accompanying drawings.

FIG. 1 is a block diagram illustrating a system for implementing blind coreset selection in accordance with some embodiments.

FIG. 2 is a flow diagram illustrating a process for implementing blind coreset selection in accordance with some embodiments.

FIG. 3 is a flow diagram illustrating a process for computing data item scores in accordance with some embodiments.

FIG. 4 shows results comparing embedding data coverage using different sampling techniques.

FIG. 5 shows a visualization of assigning scores to data items in an embedding space of unlabeled data used to select a coreset.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

State-of-the-art methods for selecting a representative subset, or coreset, of an unlabeled dataset have demonstrated impressive results in experiment settings. However, the current methods assume the full dataset is labeled and available for training prior to coreset selection. Regarding labels, it is important to acknowledge that the majority of real-world data are, in fact, unlabeled, preventing coreset consideration for label-based methods. Furthermore, labeling massive amounts of image data just to consider selection is cost prohibitive, with annotation taking anywhere between 7 seconds per bounding box to 1.5 hours for full semantic segmentation. Some innovative coreset selection methods use self-supervised learning in place of label-based training. However, this approach will still have substantial time and computation costs to select coresets at scale. Furthermore, coupling coreset selection with training on a single model architecture decreases generalization.

The problem of labeled data selection for dataset-efficient deep learning may be defined formally as follows. Given a labeled dataset

$${𝕊}^{L} = {\{ ( {x}_{i} , {y}_{i} ) \}}_{i = 1}^{N}$$

with N examples drawn independently and identically distributed (i.i.d.) from an underlying distribution P, where xᵢ are the data and yᵢ is the ground truth label for each example, the goal is to select a subset of [symbol] ^{L} to reduce future storage and training consumption while closely maintaining performance of full dataset training. The coreset may be denoted as

$${𝕊}^{C} = {\{ ( {x}_{i} , {y}_{i} ) \}}_{i = 1}^{n} ⊂ {𝕊}^{L} ,$$

which has n examples and a prune rate of

$$\frac{( 1 - n )}{N} .$$

Then, coreset selection may be formalized as:

$${arg min}_{{𝕊}^{C} ⊂ {𝕊}^{L} \vert \frac{1 - n}{N} \geq p} {𝔼}_{x , y ∼ P} [ l ( x , y ; {f}_{( {𝕊}^{C} )} ) ] , \qquad ( 1 )$$

where p is a prune rate set before training, l is the loss function, and [symbol] is a model trained on [symbol] ^{C}.

Furthermore, the problem of unlabeled data selection for data- and label-efficient deep learning, or blind coreset selection as disclosed herein, may be defined formally as follows. Given an unlabeled dataset

$$𝕊 = {\{ ( {x}_{i} ) \}}_{i = 1}^{N} ,$$

the goal of “blind” coreset selection is to select [symbol] ^{C}⊂ [symbol] without using any ground-truth label yᵢ. Hence, blind coreset selection extends dataset pruning to unlabeled data (the majority of data). Blind coreset selection may be formulated by replacing [symbol] ^{C}⊂ [symbol] ^{L} with [symbol] ^{C}⊂ [symbol] in equation 1. Notably, after selecting [symbol] ^{C}, n labels may be added to the coreset as

$${𝕊}^{C} = {\{ ( {x}_{i} , {y}_{i} ) \}}_{i = 1}^{n}$$

only to train the pruned model [symbol] . In some embodiments, term “blind” refers to the selection process operating without access to ground-truth labels, relying solely on the intrinsic structure of the data as captured in embedding representations.

Blind coreset selection uniquely increases scale and reduces labeling costs. First, while any xᵢ may be used from a labeled dataset [symbol] ^{L}, more examples x from the underlying distribution P can also be sampled and considered without any annotation or labeling requirements. In practice, this extension allows for coresets to be sourced from a much larger initial dataset. Second, the n examples can be labeled only after they are selected for pruned model training, so there is a N−n reduction in labeling costs relative to label-based coreset selection. As one specific example, using blind coreset selection at a 90% prune rate on ImageNet removes label requirements for 1.15 million images.

The systems and methods for blind coreset selection disclosed herein can be used to find a representative coreset without investing heavily in labeling, future storage, or repeated training on suboptimal data while maintaining strong performance. Results demonstrate that the systems and methods disclosed herein perform better than existing state-of-the-art methods in multiple cases and overall outperform all label-based methods save one, while reducing label and computation costs.

In some embodiments, blind coreset selection includes receiving an unlabeled dataset comprising a plurality of data items. In some embodiments, the plurality of data items includes text data. In some embodiments, the plurality of data items includes image data. In some embodiments, the unlabeled dataset comprises data items from multiple modalities (e.g., text, images, audio). In some embodiments, a separate embedding is generated for each modality using modality-specific embedding models, concatenating or fusing the embeddings to create unified multi-modal representations, and performing coreset selection on the unified embedding space. In some embodiments, the unlabeled dataset comprises temporal or sequential data (e.g., time series, video frames, streaming data). In some embodiments, temporal consistency constraints are incorporated during score computation, where temporally adjacent data items receive modified redundancy penalties to preserve temporal structure in the selected coreset.

In some embodiments, blind coreset selection further includes generating an embedding for each data item in the plurality of data items. In some embodiments, the embedding model is an artificial intelligence model (e.g., ResNet18, CLIP ViT-L-14, etc.). In some embodiments, the embedding model produces fixed-dimensional vector representations, typically ranging from 128 to 2048 dimensions, depending on the model architecture. The embeddings capture semantic relationships between data items in a continuous vector space. The systems and methods disclosed herein are generalizable to the use of any embedding model.

In some embodiments, blind coreset selection further includes computing a score for each data item in the plurality of data items using the corresponding generated embedding. In some embodiments, computing the score for each data item includes jointly assessing coverage of an embedding space and redundancy. In some embodiments, computing the score for each data item includes incrementally updating the score over a plurality of iterations based on randomly sampling a reduced-dimensional slice of the embedding space.

In some embodiments, the random sampling strategy adapts based on coverage statistics. For example, uniform sampling may be used to establish baseline coverage and the sampling distribution may be subsequently adjusted to focus on under-represented regions of the embedding space, improving coverage efficiency.

In some embodiments, blind coreset selection further includes selecting a subset of the plurality of data items based on the computed scores to form a coreset for reduced data processing.

In some embodiments, coreset selection is performed hierarchically. A coarse initial coreset is selected using reduced-resolution embeddings or clustering. Subsequently, fine-grained selection is performed within each coarse cluster, enabling scalable processing of extremely large datasets.

In some embodiments, the system computes and outputs coverage quality metrics including embedding space coverage percentage, redundancy index, diversity score, and coreset representativeness measure. These metrics enable users to assess coreset quality before downstream processing. In some embodiments, the system provides an interactive interface allowing users to: visualize the embedding space and selected coreset, manually adjust selection thresholds, exclude specific data items from consideration, and iteratively refine the coreset based on domain expertise.

In some embodiments, when new data items are added to the unlabeled dataset, the system incrementally updates the coreset without recomputing scores for all existing data items. New items are scored against the existing embedding space, and the coreset is updated based on comparative scoring.

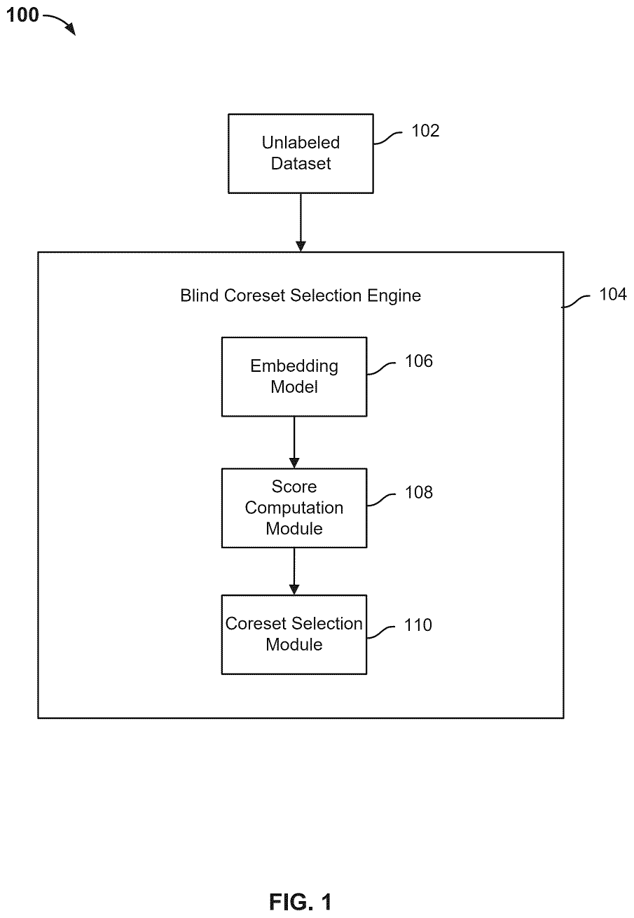

FIG. 1 is a block diagram illustrating a system for implementing blind coreset selection in accordance with some embodiments. In the example shown, system 100 includes unlabeled dataset 102 and blind coreset selection engine 104.

Unlabeled dataset 102 comprises a plurality of data items. In some embodiments, the plurality of data items includes text data. In some embodiments, the plurality of data items includes image data.

Blind coreset selection engine 104 is configured to receive unlabeled dataset 102. Blind coreset selection engine 104 includes embedding model 106, score computation module 108, and coreset selection module 110. In some embodiments, the score computation is distributed across multiple processing units. The embedding space is partitioned, with each processing unit handling a subset of iterations. Scores are aggregated across processing units to produce final importance rankings.

Embedding model 106 is configured to generate an embedding for each data item in the plurality of data items. In some embodiments, embedding model 106 is an off-the-shelf deep learning artificial intelligence model (e.g., ResNet18, CLIP ViT-L-14, etc.). In some embodiments, each embedding is a multi-dimensional numerical representation of the data item. In some embodiments, the number of dimensions is predetermined. Using off-the shelf models to generate embeddings enables the method to be broadly applicable across different data modalities and architectures.

As an off-the-shelf deep learning model, embedding model 106 may be denoted as f(·)=g(h(·)), where h is the model component mapping input data to hidden representations at a penultimate layer and g maps the embedding space to a previously learned output f. The function h(xᵢ)∈ [symbol] ^{M} may be used to generate an embedding space for input data

$$𝕊 = {\{ ( {x}_{i} ) \}}_{i = 1}^{N}$$

denoted as

$$Z = [ h ( {x}_{1} ) , … , h ( {x}_{N} ) ] ∈ {ℝ}^{N \times M} \qquad ( 2 )$$

where feature-based embedding space Z as a representation of the underlying data distribution x, y˜P in equation 1. Thus, the first objective for coreset selection can be defined as selecting examples that maximize coverage of the embedding space Z.

Score computation module 108 is configured to compute a score for each data item in the plurality of data items using the corresponding embedding generated by embedding model 106. In some embodiments, computing the score for each data item includes jointly assessing coverage of an embedding space and redundancy.

In some embodiments, computing the score for each data item includes randomly sampling a plurality of data items for a reduced-dimensional slice of the embedding space, identifying the closest data items in the reduced-dimensional slice of the embedding space to each sampled data item of the plurality of sampled data items, and incrementally updating a coverage score for each sampled data item and the identified closest data items over a plurality of iterations. In some embodiments, incrementally updating the coverage scores includes increasing each sampled data item's score to reward coverage of a large portion of the embedding space and decreasing the identified closest data items' nearest neighbors' scores to penalize redundancy.

Coreset selection module 110 is configured to select a subset of the plurality of data items received with unlabeled dataset 102 based on the scores computed by score computation module 108 to form a coreset for reduced data processing. In some embodiments, selecting a subset of the plurality of data items based on the computed scores includes selecting data items with computed scores within a predetermined threshold.

In some embodiments, blind coreset selection engine 104 is configured to output a list of scores computed by score computation module 108. In some embodiments, blind coreset selection engine 104 is configured to output the coreset selected by coreset selection module 110.

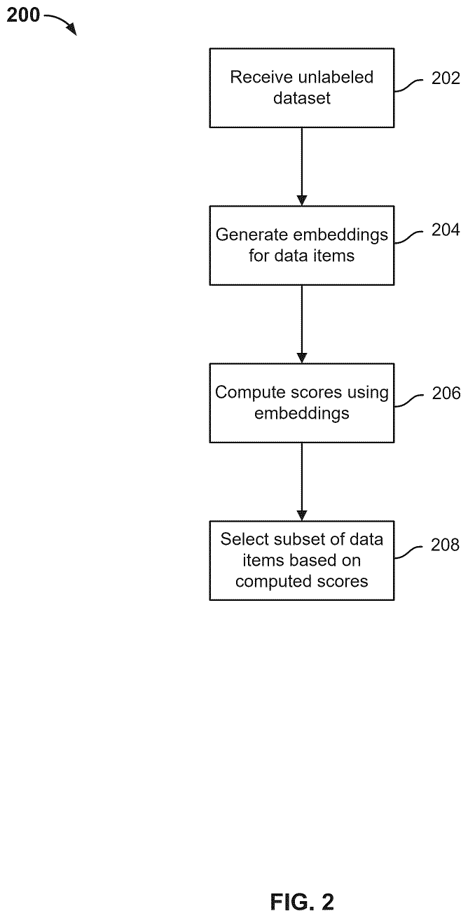

FIG. 2 is a flow diagram illustrating a process for implementing blind coreset selection in accordance with some embodiments. Process 200 may be implemented by a blind coreset selection engine such as blind coreset selection engine 104.

At 202, an unlabeled dataset comprising a plurality of data items is received. The unlabeled dataset may be an unlabeled dataset such as unlabeled dataset 102. In some embodiments, the plurality of data items includes text data. In some embodiments, the plurality of data items includes image data. In some embodiments, the plurality of data items includes another type of data which can be embedded by a deep learning model (e.g., audio data, video data, time-series data, etc.).

At 204, an embedding is generated for each data item in the plurality of data items. The embeddings may be generated by an embedding model such as embedding model 106. In some embodiments, the embedding model is an off-the-shelf deep learning artificial intelligence model (e.g., ResNet18, CLIP ViT-L-14, etc.). In some embodiments, each embedding is a multi-dimensional numerical representation of the data item. In some embodiments, the number of dimensions is predetermined.

In some embodiments, embeddings from multiple embedding models are concatenated into a single vector for each data item (e.g., a 1280-dimensional embedding space generated by concatenating vectors generated by ResNet18 with vectors generated by CLIP ViT-L-14). In some embodiments, the embeddings are generated using a single forward pass through one or more embedding models for each data item without training-based backpropagation or data saving. This approach increases generality while maintaining computational efficiency.

At 206, a score is computed for each data item in the plurality of data items using the corresponding generated embedding. In some embodiments, computing the score for each data item includes jointly assessing coverage of an embedding space and redundancy.

In some embodiments, computing the score for each data item includes randomly sampling a plurality of data items for a reduced-dimensional slice of the embedding space, identifying the closest data item and a set of nearest neighbors in the reduced-dimensional slice of the embedding space for each sampled data item of the plurality of sampled data items, and incrementally updating a coverage score for each sampled data item and the identified closest data items and sets of nearest neighbors over a plurality of iterations.

Coverage for each random sample in the reduced embedding space may be quantified by finding the closest existing dataset example and updating its coverage score. This process is repeated across many iterations, extending the estimated coverage score across all examples. Unlike random sampling, this technique rewards hard examples that individually occupy large, unique, low-density areas of the overall embedding space, thereby improving coreset selection.

At 208, a subset of the plurality of data items is selected based on the computed scores to form a coreset for reduced data processing. In some embodiments, selecting a subset of the plurality of data items based on the computed scores includes selecting data items with computed scores within a predetermined threshold.

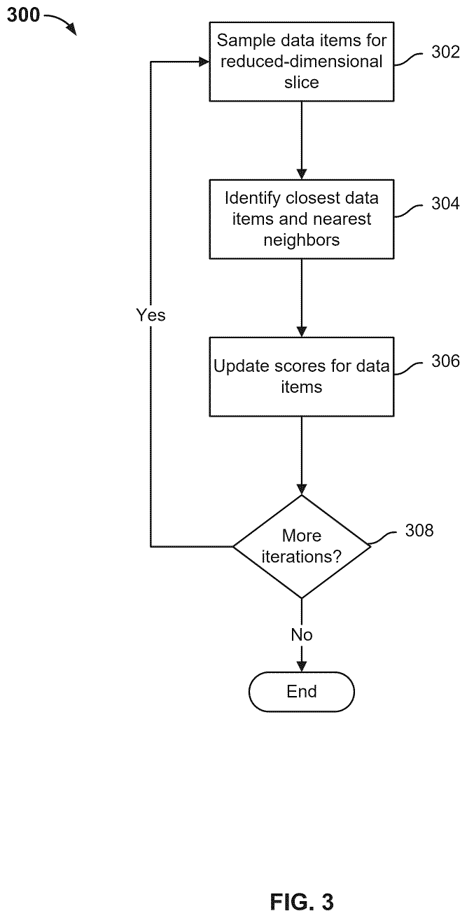

FIG. 3 is a flow diagram illustrating a process for computing data item scores in accordance with some embodiments. Process 300 may be implemented by a score computation module such as score computation module 108. Process 300 may be implemented as part of or all of step 206 of process 200.

At 302, a plurality of data items is randomly sampled for a reduced-dimensional slice of an embedding space. In some embodiments, the embedding space is a multi-dimensional embedding space determined by an embedding model, such as embedding model 106, which is used to generate an embedding for each data item of a plurality of data items received with an unlabeled dataset, such as unlabeled dataset 102. In some embodiments, the reduced-dimensional slice is randomly selected as one or more dimensions of the multi-dimensional embedding space.

In some embodiments, the random sampling is performed using a Triangular distribution over each embedding dimension of the reduced-dimensional slice. A Triangular distribution over each embedding space dimension j∈{1, . . . , M} may be defined using

$${s}_{j} \sim p ( x , j ) := \{ \begin{matrix}\frac{2 ( x - {x}_{j}^{min} )}{( {z}_{j}^{max} - {z}_{j}^{min} ) ( {z}_{j}^{med} - {z}_{j}^{min} )} & for {z}_{j}^{min} \leq x < {z}_{j}^{med} \\ \frac{2 ( {z}_{j}^{max} - x )}{( {z}_{j}^{max} - {z}_{j}^{min} ) ( {z}_{j}^{max} - {z}_{j}^{med} )} & for {z}_{j}^{med} \leq x \leq {z}_{j}^{max}\end{matrix} , \qquad ( 3 )$$

$$s := {[ {s}_{1} , … , {s}_{M} ]}^{⊤} ∈ {ℝ}^{M}$$

where s is a full random sample of

$$Z , {z}^{min} = {\{ min ( {Z}_{: , j} ) \}}_{j = 1}^{M} ∈ {ℝ}^{M}$$

is the minimum Z value for each embedding dimension, and z^{med}, z^{max}∈ [symbol] ^{M} are the corresponding median and maximum Z values.

In some embodiments, the random sampling is performed using a uniform distribution over each embedding dimension of the reduced-dimensional slice. In some embodiments, the random sampling is performed using a Gaussian distribution over each embedding dimension of the reduced-dimensional slice.

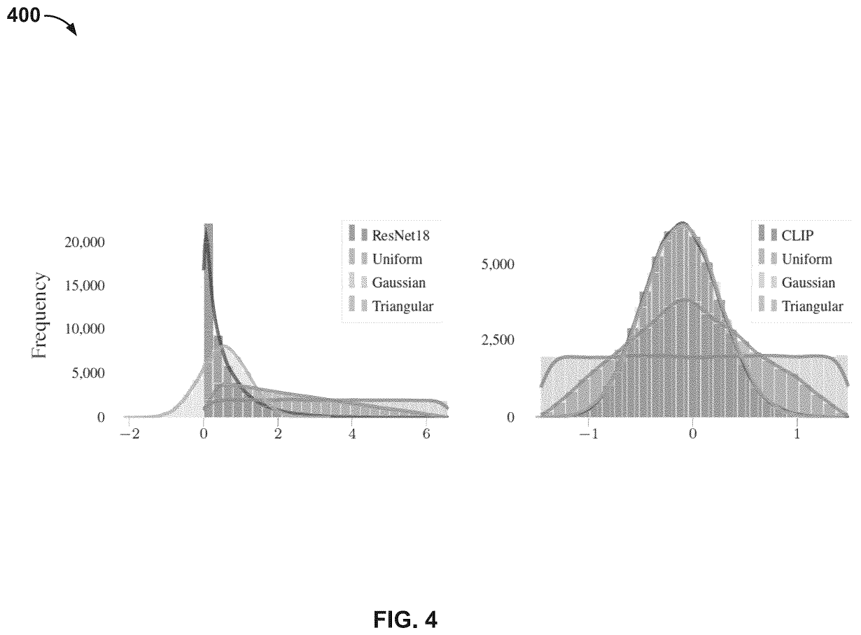

FIG. 4 shows results comparing embedding data coverage using different sampling techniques. ResNet18 (left) and CLIP (right) are the first-dimension embeddings for 50,000 CIFAR100 train set examples, while each corresponding distribution type is sampled 50,000 times. Relative to uniform or Gaussian, using a Triangular distribution in practice uniquely achieves all objectives of providing ample coverage for densely populated regions of the embedding space, covering outliers, and not over sampling empty space.

In some embodiments, sample efficiency over Z∈ [symbol] ^{N×M} is increased by reducing its dimensionality to [symbol] ^{N×M} using

$$D := [ {1}_{{d}_{1}} , … , {1}_{{d}_{m}} ] ∈ {ℝ}^{M \times m} , \qquad ( 4 )$$

$$\hat{Z} := ZD ∈ {ℝ}^{N \times m}$$

where D linearly maps Z to m reduced embedding dimensions, d=[d₁, . . . , dₘ]^{τ}∈ [symbol] ^{m} is a set of random indices chosen without replacement from {1, . . . , M}, and 1ᵢ is a one-hot vector with i-th element equal to 1. In other words, D is used to randomly select a subset of m≤M indices to represent Z in a lower dimensional subspace \hat{Z}. In addition to Z, the dimension of random sampling s∈ [symbol] ^{M} in equation 3 is reduced using equation 4 to find ŝ: =sD∈ [symbol] ^{m}.

At 304, the closest data item and a set of nearest neighbor data items are identified for each sampled data item of the plurality of sampled data items. In some embodiments, the closest data items and the sets of nearest neighbors are identified through computing the distance between data items in the reduced-dimensional slice of the embedding space using a distance metric. In some embodiments, the distance metric used is Manhattan distance. In some embodiments, other metrics are used (e.g., L2, cosine, or Mahalanobis distance). In some embodiments, the set of nearest neighbor data items is determined in relation to the identified closest data item.

In some embodiments, the closest data item is found using

$${arg min}_{i} {‖ \hat{s} - {\hat{Z}}_{i} ‖}_{1} , \qquad ( 5 )$$

In some embodiments, the number of nearest neighbor data items in each set is predetermined. In some embodiments, the number of nearest neighbor data items in each set is between 10 and 10,000.

At 306, coverage scores for each identified closest data items and each of the nearest neighbors of the identified sets of nearest neighbors are updated. In some embodiments, the coverage scores for the closest data item are incremented, reflecting their contribution to representing that region of the embedding space.

In some embodiments, the coverage score for the closest data item may be defined as follows by denoting k as the solution to i in equation 5 such that \hat{Z}ₖ is the closest dataset example to sampled data item ŝ. Thus, the importance score (s^{C}) for coverage may be computed as

$${s}_{i}^{C} := \{ \begin{matrix}1 & for i = k \\ 0 & otherwise\end{matrix} \qquad ( 6 )$$

$${s}^{C} := [ {s}_{1}^{C} , … , {s}_{N}^{C} ] ∈ {ℝ}^{N} ,$$

where s^{C} adds to the embedding coverage contribution estimate for dataset example k. Unlike random sampling, this coverage score rewards hard examples that individually occupy large, unique, low-density areas of the overall embedding space, which improves coreset selection

In some embodiments, each of the nearest neighbor data items receives a redundancy penalty. The redundancy penalty may decrease as the distance from the sampled data item increases. The decrease in the redundancy penalty may be determined according to an exponential decay function, whereby the redundancy penalty decays exponentially with distance. In some embodiments, the redundancy penalty may be determined by other monotone decreasing functions according to the distance between a nearest neighbor data item and a closest data item.

In some embodiments, redundancy is computed in relation to each closest data item solution k in equation 5. Specifically, for each coverage example \hat{Z}ₖ, redundancy is quantified for the set of [symbol] ∈ [symbol] ^{α} nearest neighbors as

$${v}^{R} := \{ \begin{matrix}{( {‖ {\hat{Z}}_{k} - {\hat{Z}}_{i} ‖}_{1} )}^{- β} & for i ∈ 𝕂 \\ 0 & otherwise\end{matrix} , \qquad ( 7 )$$

where exponential β determines how quickly the penalty changes between neighbors with varying distances to \hat{Z}ₖ of ∥\hat{Z}ₖ− \hat{Z}ᵢ∥₁. In this example, using v^{R}∈ [symbol] ^{N}, a redundancy score may be defined as

$${s}^{R} := \frac{{v}^{R}}{{‖ {v}^{R} ‖}_{1}} , \qquad ( 8 )$$

where ∥v^{R}∥₁∈ [symbol] normalizes s^{R}∈ [symbol] ^{N} so that the coverage and redundancy scores are balanced as ∥s^{R}∥₁=∥s^{C}∥₁=1.

In process 300, the scores computed for the plurality of data items received with an unlabeled dataset are incrementally updated over a plurality of iterations. At 308, it is determined whether there are more iterations remaining. In some embodiments, the plurality of iterations needed for computing scores for the plurality of data items includes a predetermined number of iterations. If it is determined that there are more iterations remaining, process 300 returns to 302.

Repeating the process of randomly sampling the embedding space and subsequently adding coverage for the closest data items across many iterations extends the estimated coverage score across all data items of the plurality of data items. This coverage score therefore rewards hard examples that individually occupy large, unique, low-density areas of the overall embedding space, which improves coreset selection.

If it is determined that there are no more iterations remaining, process 300 ends.

The final importance score for each data item may be calculated as its final coverage score minus its final redundancy score. For example, using the embedding sampling process for ŝ in 5 and subsequent coverage s^{C} and s^{S} scores, the final importance score s∈ [symbol] ^{N} may be defined as

$$s := {\sum }_{t = 1}^{T} {s}_{t}^{C} ( {\hat{s}}_{t} ) - {s}_{t}^{R} ( {k}_{t} ) , \qquad ( 9 )$$

where ŝₜ is the random embedding space sample ŝ at iteration t with corresponding coverage score

$${s}_{t}^{C} ( {\hat{s}}_{t} ) , {k}_{t}$$

is the example solution in equation 5 at iteration t with corresponding redundancy score

$${s}_{t}^{R} ( {k}_{t} ) ,$$

and T is the overall number of sample and score iterations. Notably, each iteration t is independent, which enables us parallelize our importance score for accelerated computation.

In this example, after finding s as the importance score to rank all data items in unlabeled dataset [symbol] , the n data items with highest scores may be selected as the pruned coreset for model training. In some examples, s can be used to weight the loss and gradient for model training using

$$w = \frac{s + min ( s )}{max ( s ) - min ( s )} , \qquad ( 10 )$$

where w=[w₁, . . . , w_{N}]^{τ}∈ [symbol] ^{N}, wᵢ∈[0,1], and the loss is scaled each batch by the mean wᵢ score corresponding to the specific training examples in that batch.

In some embodiments, a ranking of importance scores may be provided to a user. In some embodiments, a pruned dataset comprising a plurality of data items may be provided to the user. In some embodiments, the data items of the provided plurality of data items are selected based on having final importance scores greater than a predetermined threshold. In some embodiments, the data items of the provided plurality of data items are selected as being the top-ranked data items based on importance score. In this case, the number of data items in the provided plurality of data items may be predetermined.

In some embodiments, to increase computational efficiency, the dimensionality of the embedding space may be reduced by randomly selecting a subset of dimensions for each iteration. In some embodiments, the number of reduced dimensions is between 1 and 100. For example, in practical experiments, the number of reduced embedding dimensions is set to 2, enabling a large number of unique 2-D embedding space slices over numerous sampling iterations.

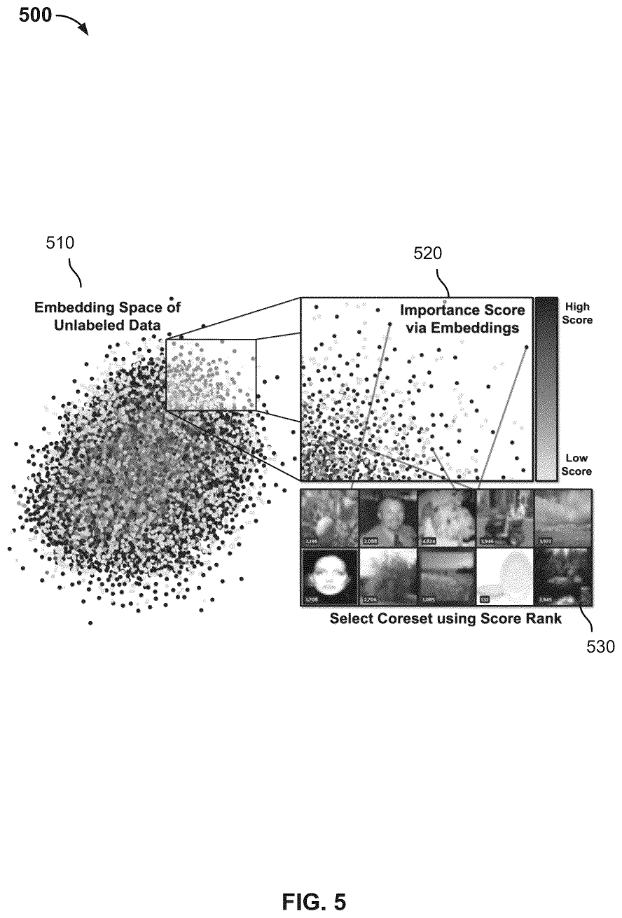

FIG. 5 shows a visualization of assigning scores to data items in an embedding space of unlabeled data used to select a coreset. In the example shown, embedding space 510 is an embedding space created by generating embeddings of data items from an unlabeled data set such as unlabeled dataset 102. Section 520 of the visualization displays a close-up view of importance scores from one region of the embedding space, where darker-colored points indicate that a data item has been assigned a higher importance, or coverage, score. Select coreset 530 displays a selection of ten data items that have been assigned high scores that are selected to be included in the coreset for reduced data processing.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
receiving an unlabeled dataset comprising a plurality of data items;
generating an embedding for each data item in the plurality of data items using an embedding model;
computing a score for each data item in the plurality of data items using the corresponding generated embedding including by jointly assessing coverage of an embedding space and redundancy; and
selecting a subset of the plurality of data items based on the computed scores to form a coreset for reduced data processing.

2. The method of claim 1, wherein the plurality of data items includes text data.

3. The method of claim 1, wherein the plurality of data items includes image data.

4. The method of claim 1, wherein the embedding model is an artificial intelligence model.

5. The method of claim 1, wherein computing the score for each data item includes:
randomly sampling a plurality of data items for a reduced-dimensional slice of the embedding space;
identifying the closest data item and a set of nearest neighbor data items for each sampled data item of the plurality of sampled data items; and
incrementally updating scores for the closest data items and the nearest neighbors of the sets of nearest neighbors over a plurality of iterations.

6. The method of claim 5, wherein the random sampling is performed using a Triangular distribution over each embedding dimension of the reduced-dimensional slice.

7. The method of claim 5, wherein the random sampling is performed using a uniform distribution over each embedding dimension of the reduced-dimensional slice.

8. The method of claim 5, wherein the random sampling is performed using a Gaussian distribution over each embedding dimension of the reduced-dimensional slice.

9. The method of claim 5, wherein the closest data item and the set of nearest neighbors for each sampled data item are identified through computing a distance between data items in the reduced-dimensional slice of the embedding space using a distance metric.

10. The method of claim 9, wherein the distance metric used is Manhattan distance.

11. The method of claim 5, wherein the reduced-dimensional slice comprises one or more dimensions of the embedding space randomly selected at each iteration of the plurality of iterations.

12. The method of claim 5, wherein incrementally updating the scores includes increasing each closest data item's score to reward coverage of a large portion of the embedding space and decreasing the nearest neighbors' scores to penalize redundancy.

13. The method of claim 5, wherein the plurality of iterations includes a predetermined number of iterations.

14. The method of claim 1, wherein selecting a subset of the plurality of data items based on the computed scores includes selecting data items with computed scores within a predetermined threshold.

15. A system, comprising:
a processor configured to:
receive an unlabeled dataset comprising a plurality of data items;
generate an embedding for each data item in the plurality of data items using an embedding model;
compute a score for each data item in the plurality of data items using the corresponding generated embedding including by jointly assessing coverage of an embedding space and redundancy; and
select a subset of the plurality of data items based on the computed scores to form a coreset for reduced data processing; and
a memory coupled to the processor and configured to provide the processor with instructions.

16. The system of claim 15, wherein the embedding model is an artificial intelligence model.

17. The system of claim 15, wherein computing the score for each data item includes:
randomly sampling a plurality of data items for a reduced-dimensional slice of the embedding space;
identifying the closest data item and a set of nearest neighbor data items for each sampled data item of the plurality of sampled data items; and
incrementally updating coverage scores for the closest data items and the nearest neighbors of the sets of nearest neighbors over a plurality of iterations.

18. The system of claim 17, wherein updating the coverage scores includes increasing each closest data item's score to reward coverage of a large portion of the embedding space and decreasing the nearest neighbors' scores to penalize redundancy.

19. The system of claim 15, wherein selecting a subset of the plurality of data items based on the computed scores includes selecting data items with computed scores within a predetermined threshold.

20. A computer program product embodied in a non-transitory computer readable medium and comprising computer instructions for:
receiving an unlabeled dataset comprising a plurality of data items;
generating an embedding for each data item in the plurality of data items using an embedding model;
computing a score for each data item in the plurality of data items using the corresponding generated embedding including by jointly assessing coverage of an embedding space and redundancy; and
selecting a subset of the plurality of data items based on the computed scores to form a coreset for reduced data processing.
